(19) United States
(12) Patent Application Publication
(10) Pub. No.: US 2007/0058867 A1
(43) Pub. Date: Mar. 15, 2007

(54) Portable device which does translation and retrieval of information related to a text object

(76) Inventor: Johnny Meng-Han Shieh, Austin, TX (US)

Correspondence Address: IBM CORP (YA);C/O YEE & ASSOCIATES PC, P.O. BOX 802333, DALLAS, TX, 75380, US

(21) Appl. No.: 11/226,966

(22) Filed: Sep. 15, 2005

(51) Int. Cl. G06K 9/18; G06K 7/10

(52) U.S. Cl. 382/182; 382/321

(57) ABSTRACT

The present invention provides a method, system and apparatus for translation and retrieval of information related to a text object. In a preferred embodiment, the apparatus comprises a housing with a viewing area for viewing text objects placed under the viewing area and a scanner that is capable of scanning the underlying set of text objects. The apparatus also has some form of communications interface with a data processing system. The apparatus also has a display area for displaying translated text information from the data processing system to the user.

### BACKGROUND OF THE INVENTION

1. Field of the Invention

The present invention relates generally to the information processing field. Specifically, the present invention relates to a method, apparatus and computer program product for translation and retrieval of information related to a text object.

2. Description of the Related Art

Today, more than ever, people are inundated with mounds of paper. Books, bills, advertisements, junk mail, everything is presented in a hardcopy form. Many times, data presented on the hardcopy documentation is difficult to resolve. For example, there may be a telephone number on a long distance bill that is unfamiliar. Determining if there is a billing error and finding the source of the phone number can be time consuming and frustrating.

Another example of data that is difficult to resolve is text written in another language. Locating a dictionary to translate the text may be impractical or time consuming and inconvenient.

Therefore, it would be advantageous to have an improved method, apparatus and computer program product to translate and retrieve information related to a text object.

### SUMMARY OF THE INVENTION

The present invention provides a method, system and apparatus for translation and retrieval of information related to a text object. In a preferred embodiment, the apparatus comprises a housing with a viewing area for viewing text objects placed under the viewing area and a scanner that is capable of scanning the underlying set of text objects. The apparatus also has some form of communications interface with a data processing system. The apparatus also has a display area for displaying translated text information from the data processing system to the user.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the present invention may be implemented, in accordance with a preferred embodiment of the invention.

FIG. 2 is a block diagram of a data processing system in which the present invention may be implemented.

FIG. 3 is a pictorial representation of a hand-held translation device, in accordance with a preferred embodiment of the present invention.

FIG. 4 is a block diagram of a hand-held translation device system, in accordance with a preferred embodiment of the present invention.

FIG. 5 is a block diagram of a portion of a cell phone bill, in accordance with a preferred embodiment of the invention.

FIG. 6 is a block diagram of a portion of a cell phone bill, in accordance with a preferred embodiment of the invention.

FIG. 7 is a block diagram of a portion of a cell phone bill, in accordance with a preferred embodiment of the invention.

FIG. 8 is a flowchart that illustrates a method for instant translation and retrieval of information related to a text object, in accordance with a preferred embodiment of the invention.

### DETAILED DESCRIPTION OF THE PREFERRED EMBODIMENT

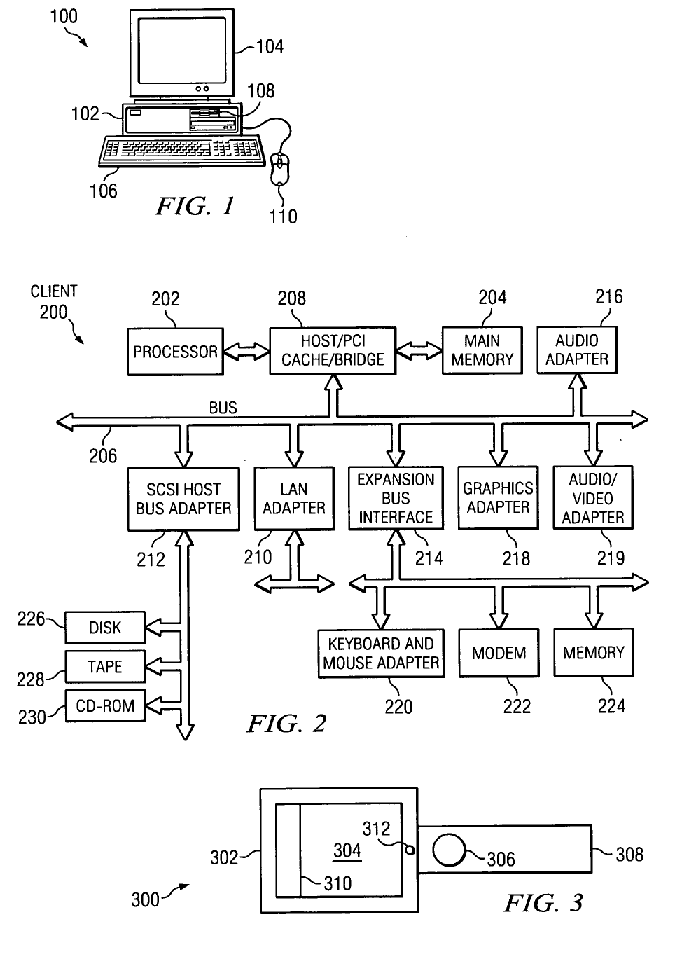

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eserver computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in connectors. In the depicted example, local area network (LAN) adapter 210, small computer system interface (SCSI) host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance.

The processes of the present invention are performed by processor 202 using computer implemented instructions, which may be located in a memory such as, for example, main memory 204, memory 224, or in one or more peripheral devices 226-230.

Turning to FIG. 3, FIG. 3 is a pictorial representation of a hand-held translation device, in accordance with a preferred embodiment of the present invention. Hand-held translation device (HTD) 300 is comprised of housing 302 and viewer 304. Viewer 304 is comprised of a transparent LCD screen. All of the LCD crystals of viewer 304 are aligned so that viewer 304 is transparent. Actuator 306 is a button, which when pressed causes HTD 300 to scan the underlying set of text objects using scanner 310. Scanner 310 is contained within housing 302. Port 308 is a communications port. Motion sensor 312 detects movement of housing 302 and causes scanner 310 to activate if any movement is detected.

In a preferred embodiment, HTD 300 communicates with a data processing system, such as data processing system 200 in FIG. 2, through a wireless connection, at port 308. However, in another embodiment HTD 300 could be connected to a data processing system through a direct cable connection at port 308.

While actuator 306 is depicted as a button in FIG. 3, those skilled in the art will appreciate that actuator 306 can take many shapes and forms, including, but not limited to, a switch, a dial, a knob, or a toggle, etc. Additionally, actuator 306 could be placed in a variety of locations on housing 302. Moreover, housing 302 could take many shapes, depending upon the particular implementation. For example, the handle could be omitted, the viewing area and viewer 304 could be round, etc.

Furthermore, actuator 306 could be omitted altogether and all scanning could be controlled by motion sensor 312. Conversely motion sensor 312 could be omitted and all scanning could be controlled solely through use of actuator 306. Additionally, there could be multiple instances of actuator 306, as one actuator might be a scanner control and another actuator might be a power switch. Also, while motion sensor 312 has been depicted as occurring in a single instance at one location in the housing of HTD 300, those skilled in the art will appreciate that motion sensor 312 could be placed anywhere on HTD 300 or there could be multiple occurrences of motion sensor 312 through various locations on HTD 300.

In alternate embodiment, housing 302 may even have a light attached so as to illuminate the underlying set of text objects for better viewing. This light could be controlled via actuator 306 or through another, separate actuator.

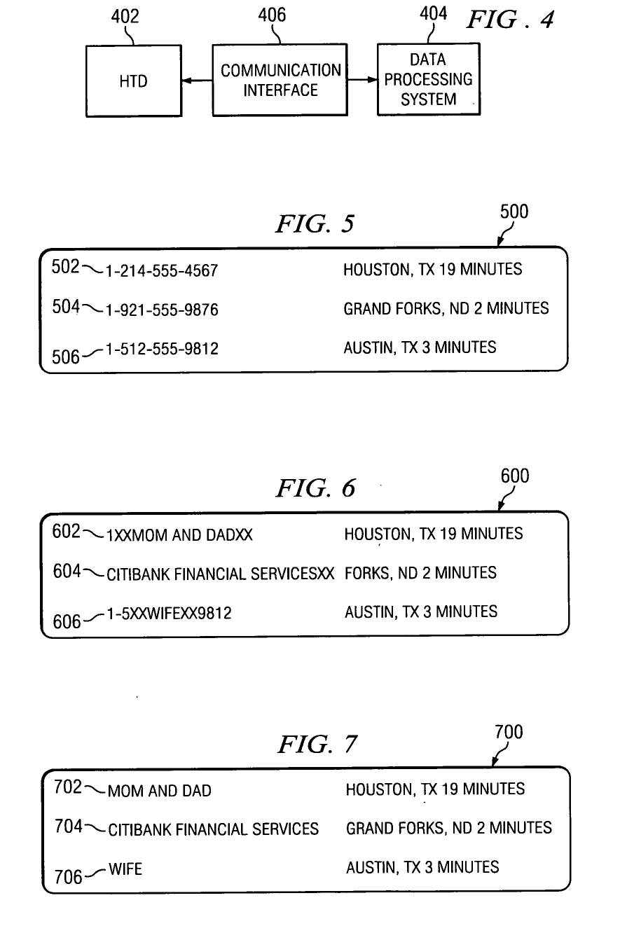

FIG. 4 is a block diagram of a hand-held translation device system 400, in accordance with a preferred embodiment of the present invention. HTD 402 is an example of a hand-held translation device that can be implemented as HTD 300 in FIG. 3. Data processing system 404 is an example of a data processing system that can be implemented as data processing system 200 in FIG. 2. Communications interface 406 allows HTD 402 to communicate with data processing system 404. Communications interface 406 can take many forms, including, but not limited to, a wireless connection, a universal serial bus (USB) connection or a direct cable connection of another type, depending upon implementation. In an exemplary embodiment, communications interface 406 is connected via a wireless connection to HTD 402 at a communications port, such as port 308 in FIG. 3, and to data processing system 404 through a communication port connected to a bus, such as bus 206 in FIG. 2.

FIG. 5 is a block diagram of a portion of a cell phone bill, in accordance with a preferred embodiment of the invention. Cell phone bill 500 is a portion of a cell phone bill as it might appear through viewer 304 of HTD 300, in FIG. 3. Cell phone bill 500 comprises three billing items 502, 504 and 506. Take the example where the user does not recognize billing item 504. In such a case, the user wants to ascertain if billing item 504 has been erroneously charged. To do this, the user may call the phone number shown in billing items 504, but this would cause additional charges or the user could call the cell phone company and try to ascertain if he/she actually made the call. But this process is time consuming and can prove to be frustrating.

The present invention solves these deficiencies by translating, or looking up the information for the user. The user would place HTD 300 over cell phone bill 500 and press actuator 306. This causes HTD 300 to perform a scan of the text of cell phone bill 500 and send the scanned image to a data processing system, such as data processing system 200 in FIG. 2, to translate those variables that need to be translated. For example, as Austin, Houston and Grand Forks are all known city names, they are not translated. However, the telephone numbers are not known and therefore the HTD program concentrates on translating, or looking up, those numbers.

In the present example, a lookup is performed in the users personal database first. In this case it is determined that the phone number in billing item 502 belongs to the user's parents and the phone number in billing items 506 belongs to the user's wife. However, there is no information in the user's personal database concerning the phone number in billing item 504. Therefore, according to user specified rules, a search is performed on the web. The phone number in billing item 504 is looked up in various listed reverse-number directories. In this example, the phone number in billing item 504 is determined to belong to Citibank Financial Services. The data processing system sends this information back to HTD 300 and the information is displayed in viewer 304 for the user to see. FIGS. 6 and 7 illustrate two different ways in which this information is displayed to the user.

FIG. 6 is a block diagram of a portion of a cell phone bill, in accordance with a preferred embodiment of the invention. Cell phone bill 600 comprises three billing items, such as billing items 502, 504 and 506 from FIG. 5. Cell phone bill 600 is a portion of a cell phone bill as it might appear through viewer 304 of HTD 300, in FIG. 3. Overlays 602, 604 and 606 contain the translation of the phone numbers in billing items 502, 504 and 506. In a preferred embodiment, overlays 602, 604 and 606 appear with a “frosted background” in viewer 304 superimposed above the translated text objects, obfuscating the underlying text objects. The rest of the area of viewer 304 remains transparent, allowing the user to see the rest of the underlying text.

In another embodiment, when the translated text is present to the user in viewer 304, viewer 304 becomes opaque and entirely blocks the underlying text from the user's view, as shown in FIG. 7. FIG. 7 is a block diagram of a HTD viewer, such as viewer 304 of HTD 300, in FIG. 3, in accordance with a preferred embodiment of the invention. Viewer 700 is opaque such that none of the underlying translated text appears visible through viewer 700. Instead viewer 700 replicates the underlying text objects along with the translated text, as shown by replicated items 702, 704 and 706. Replicated items 702, 704 and 706 are comprised of the translation of the phone numbers in billing items 502, 504 and 506 plus the portions of billing items 502, 504 and 506 that did not need to be translated. The untranslated portions of billing items 502, 504 and 506, have been offset sufficiently from the translated portions to prevent over lapping of the two portions of text so that replicated items 702, 704 and 706 are reproduced in a clear, legible arrangement.

It is important to note that while the present invention has been described above in terms of presenting replicated items that are comprised of the translation of portions of the underlying text plus the untranslated portions of the underlying text, those of ordinary skill in the art will appreciate the replicated items could consist of various portions of the underlying text, depending upon the implementation. For example, the replicated items could include the translated text plus the entire underlying text object. In the example presented above, an alternate version of the replicated items could include the translated text plus the city and state names, but not the call duration.

Additionally, it is important to note that while the present invention has been described in the example above in terms of translating text objects comprised of numbers, the present invention is equally suited to translate text objects consisting of only text. For example, HTD 300 could be used to scan and translate sections of text presented in a foreign language. For example, take the case where a person wants to fax an article or document to a colleague in Germany, who has been looking for the article. However, the sender wants to be sure that a particular, key element or point is actually in the article. The sender can use the HTD device to scan and translate the article until the key element or point is found. The sender could then highlight that portion of the article and then fax the article to their colleague.

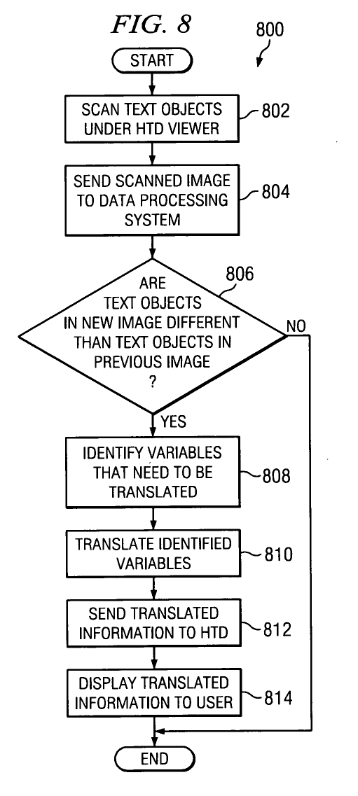

FIG. 8 is a flowchart that illustrates a method for instant translation and retrieval of information related to a text object, in accordance with a preferred embodiment of the invention. The method is designated by reference number 800 and begins when the user places a set of text objects under a HTD, such as HTD 300 in FIG. 3 and presses an actuator, such as actuator 306 in FIG. 3, causing the HTD to perform a scan of the set of text objects under the HTD's viewer, such as viewer 302 in FIG. 3 (step 802). The set of text of objects can be comprised of one or more text objects. The scanned image is sent to the data processing system, such as data processing system 200 in FIG. 2, that the HTD is linked to (step 804). Using Optical Character Recognition (OCR) software, the data processing system compares the image just sent by the HTD to the previous image sent by the HTD and determines if the text objects in the new image are different than the text objects in the previous image (step 806). If the text objects in the new image are not different than the text objects in the previous image (a no output to step 806), the method ends. This prevents accidentally duplicating the scanning and translation of text due to the HTD being jarred or shaken.

If the text objects in the new image are different than the text objects in the previous image (a yes output to step 806), the data processing system identifies the variables with the text objects that need to be translated (step 808). The data processing system translates the variables (step 810) and sends the translated information to the HTD (step 812), which then displays the translated information on its viewer (step 814).

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such a floppy disc, a hard disk drive, a RAM, and CD-ROMs and transmission-type media such as digital and analog communications links.

The description of the present invention has been presented for purposes of illustration and description, but is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for translation and retrieval of information related to a text object, the method comprising:
scanning a set of text objects, wherein the text objects are visible to a user through a viewing area;
identifying portions of the set of text objects to be translated;
translating identified portions of the set of text objects to form translated items; and
displaying the translated items in the viewing area to a user.

2. The method of claim 1, wherein the step of translating identified portions of the set of text objects is performed by a search.

3. The method of claim 2, wherein in a search can be a reverse lookup, a look up, a lookup on the internet or a reverse lookup on the internet.

4. The method of claim 1, wherein the step of identifying portions of the set of text objects to be translated is performed by an OCR application.

5. The method of claim 1, wherein the step of scanning the set of text objects is performed by a hand-held, portable scanner.

6. The method of claim 1, wherein the translated items are displayed in the viewing area, superimposed over the text objects.

7. The method of claim 6, wherein the viewing area is opaque.

8. The method of claim 1, wherein the step of scanning the set of text objects is initiated by a motion sensor.

9. The method of claim 1, wherein the step of scanning the set of text objects is initiated by an actuator.

10. An apparatus for translation and retrieval of information related to a text object, the apparatus comprising:
a housing;
viewing mechanism in the housing for viewing a set of text objects;
scanning mechanism attached to the housing for scanning the set of text objects;
communicating mechanism attached to the housing for communicating with a data processing system; and
displaying mechanism in the housing for displaying translated text information from a data processing system.

11. The apparatus of claim 10, wherein the viewing mechanism and the displaying mechanism are the same mechanism.

12. The apparatus of claim 10, wherein the viewing mechanism and the displaying mechanism comprises LCD crystals

13. The apparatus of claim 12, wherein the LCD crystals comprises LCD crystals aligned so as to be transparent.

14. The apparatus of claim 10, wherein the housing comprises a portable, hand-held housing.

15. The apparatus of claim 10, wherein the communication mechanism is any signal bearing mechanism.

16. The apparatus of claim 10, further comprising a motion sensor mechanism in the housing for detecting movement of the housing.

17. A data processing system for translation and retrieval of information related to a text object, the data processing system comprising:
a hand-held translation device;
a bus system;
a communications unit connected to the bus system, wherein data is sent and received using the communications unit;
a memory connected to the bus system, wherein a set of instructions are located in the memory; and
a processor unit connected to the bus system, wherein the processor unit executes the set of instructions to receive a set of text objects scanned by the hand-held translation device, identify portions of the set of text objects to be translated, translate identified portions of the set of text objects to form translated items and send the translated items to the hand-held translation device to be displayed for the user in a viewing area of the hand-held translation device.

18. The data processing system of claim 17, wherein the step of identifying portions of the set of text objects to be translated is performed by an OCR application.

19. The data processing system of claim 17, wherein the step of translating identified portions of the set of text objects is performed by a search.

20. The data processing system of claim 17, wherein in a search can be a reverse lookup, a look up, a lookup on the internet or a reverse lookup on the internet.
